(19) United States
(12) Patent Application Publication
(10) Pub. No.: US 2013/0159735 A1
(43) Pub. Date: Jun. 20, 2013

(54) POWER MANAGEMENT SYSTEM AND METHOD

(71) Applicants: KUEI-CHIH HOU, New Taipei (TW); YUEH-NU HSIEH, New Taipei (TW)

(72) Inventors: KUEI-CHIH HOU, New Taipei (TW); YUEH-NU HSIEH, New Taipei (TW)

(21) Appl. No.: 13/676,210

(22) Filed: Nov. 14, 2012

(30) Foreign Application Priority Data
Dec. 19, 2011 (TW) 100147099

(51) Int. Cl. G06F 1/26

(52) U.S. Cl. 713/300

(57) ABSTRACT

A power management system of a server includes a power supply unit, and a power backup unit connecting to an input terminal and an output terminal of the power supply unit. The power backup unit further includes a charging unit, a power storage unit, and a converting unit. The charging unit uses an output power from the output terminal to charge the power storage unit when an external power source is supplying power to the power supply unit. The converting unit converts a stored power of the power storage unit to provide a backup power to the input terminal when the external power source is shutdown. The disclosure further provides a power management method.

### BACKGROUND

1. Technical Field

The present disclosure relates to a power management system and a power management method, and particularly to a power management system and a power management method for a server system.

2. Description of Related Art

An uninterruptable power supply (UPS) and an external power source are installed to supply power to a conventional server. When the server experiences a sudden power failure of the external power source, the UPS will replace the failed power source.

The UPS uses a rectifier to convert an alternating current (AC) power of the external power source to a direct current (DC) power and then charges the battery or batteries in the UPS. The UPS uses an inverter to convert the DC power of the batteries to the AC power and supplies power to the server. Then, a power supply unit (PSU) of the server receives the AC power of the inverter and also converts the AC power to the DC power again for providing the DC power to the server. However, both of the rectifier in the UPS and the PSU in the server will consume some energy in the power conversion processes. Thus, the energy consumption will be increased due to the repeated conversion processes. In addition, cost of the server will be also increased due to extra use of the rectifier in the UPS.

Therefore, there is need for improvement in the art.

### BRIEF DESCRIPTION OF THE DRAWINGS

Many aspects of the present disclosure can be better understood with reference to the following drawing(s). The components in the drawing(s) are not necessarily drawn to scale, the emphasis instead being placed upon clearly illustrating the principles of the present disclosure. Moreover, in the drawing(s), like reference numerals designate corresponding parts throughout the several views.

FIG. 1 is a block diagram of an embodiment of a power management system of the present disclosure.

FIG. 2 is a flowchart of an embodiment of a power management method of the present disclosure.

### DETAILED DESCRIPTION

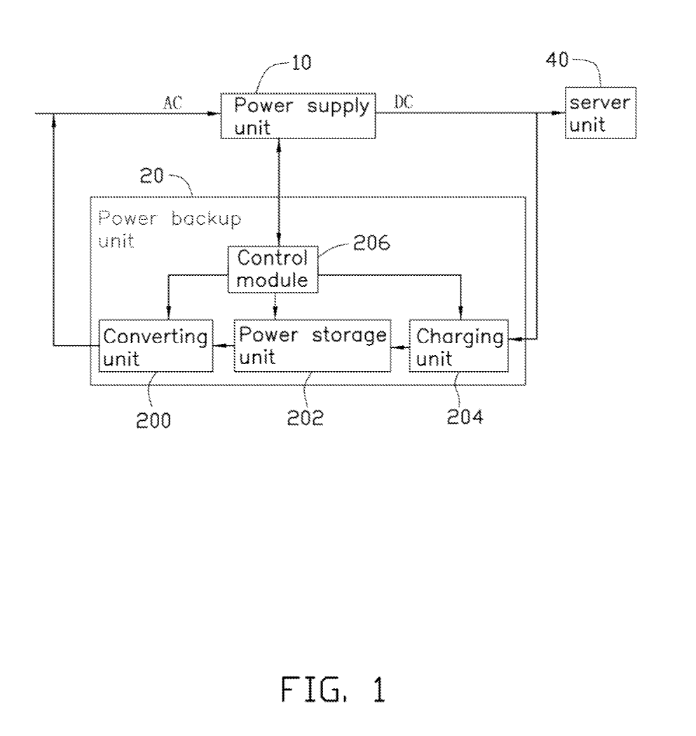

Referring to FIG. 1, an embodiment of a power management system is shown. The power management system includes a power supply unit (PSU) 10 and a power backup unit 20. The power management system supplies power to a server unit 40 in a server system. In the embodiment, the PSU 10 and the power backup unit 20 can be set in a casing of the server system.

The PSU 10 includes an input terminal and an output terminal. An external power source connects to the input terminal of the PSU 10. The PSU 10 converts a first alternating current (AC) power received from the external power source to a first direct current (DC) power. Then, the PSU 10 provides the first DC power to the server unit 40 through the output terminal of the PSU 10 for supplying power to the server unit 40.

The power backup unit 20 includes a converting unit 200, a power storage unit 202, a charging unit 204, and a control module 206. The power backup unit 20 connects to the input terminal of the PSU 10 through the converting unit 200. The power backup unit 20 connects to the output terminal of the PSU 10 through the charging unit 204. The power storage unit 202 connects the converting unit 200 and the charging unit 204. The control module 206 connects to the converting unit 200, the power storage unit 202, and the charging unit 204 to control the converting unit 200, the power storage unit 202, and the charging unit 204. The control module 206 can obtain charging capacity information from the power storage unit 202 to determine whether the remaining capacity of the power storage unit 202 is high enough to supply power to the server unit 40. In the embodiment, the power backup unit 20 is a battery backup unit (BBU), the converting unit 200 is an inverter, the power storage unit 202 is a battery pack, and the charging unit 204 is a charger. In other embodiments, the power backup unit 20 can use other power storage devices to store power.

According to the operating principle of the PSU 10, the PSU 10 can generate an AC_OK signal to indicate power state of the external power source. Then, the control module 206 receives the AC_OK signal and determines the power state of the external power source according to the AC_OK signal. If the PSU 10 receives the first AC power of the external power source, the AC_OK signal received by the control module 206 will be a high level AC_OK signal. If the PSU 10 does not receive the first AC power of the external power source, the AC_OK signal received by the control module 206 will be a low level AC_OK signal. Thus, the control module 206 can determine whether the received AC_OK signal is a high level AC_OK signal or a low level AC_OK signal to determine the power state of the external power source.

When the PSU 10 receives the first AC power of the external power source, the control module 206 receives the high level AC_OK signal and controls the charging unit 204 to charge the power storage unit 202. The charging unit 204 receives the first DC power from the output terminal of the PSU 10 to charge the power storage unit 202. Thus, the power storage unit 202 stores a second DC power and increases the remaining capacity. When the power storage unit 202 is fully charged, the charging unit 204 stops charging the power storage unit 202.

When the PSU 10 does not receive the first AC power of the external power source, the control module 206 receives the low level AC_OK signal. For example, the external power source is shut down. Then, the control module 206 checks the remaining capacity of the power storage unit 202. If the remaining capacity of the power storage unit 202 is high enough to supply power to the server unit 40, the control module 206 controls the power storage unit 202 to discharge. The control module 206 controls the converting unit 200 to convert the second DC power of the power storage unit 202 to a second AC power and to provide the second AC power to the input terminal of the PSU 10. At the same times, the PSU 10 also converts the second AC power to a third DC power to keep supplying power to the server unit 40. Thus, the server unit 40 can keep operating to store data which has not been stored when the sudden power failure happens. If the remaining capacity of the power storage unit 202 is too low to supply power to the server unit 40, the control module 206 controls the power storage unit 202 and the converting unit 200 not to operate.

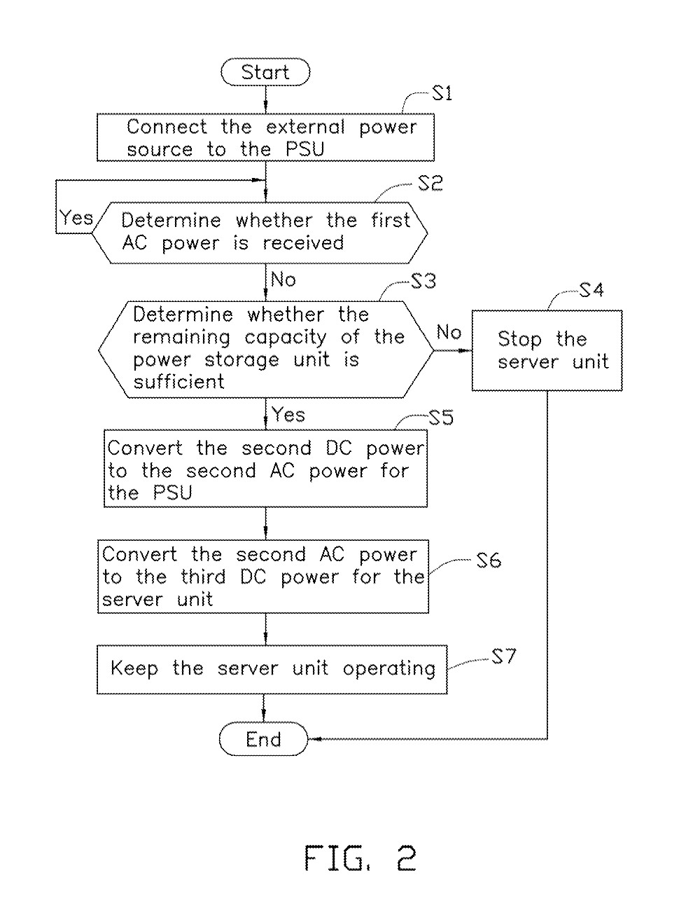

As shown in FIG. 2, an embodiment of the power management method is as follows:

In step S1, the external power source is connected to the input terminal of the PSU 10.

In step S2, the control module 206 determines whether the PSU 10 receives the first AC power. If the external power source is operating, the PSU 10 can receive the first AC power of the external power source through the input terminal and convert the first AC power to the first DC power to supply power to the server unit 40. Simultaneously, the control module 206 controls the charging unit 204 to charge the power storage unit 202. In addition, the control module 206 keeps determining whether the PSU 10 receives the first AC power and step S2 is repeated. If the external power source is not operating, the PSU 10 does not receive the first AC power and the procedure goes to step S3.

When the control module 206 receives the high level AC_OK signal from the PSU 10, the control module 206 controls the charging unit 204 to receive the first DC power to store the second DC power of the power storage unit 202. When the control module 206 receives the low level AC_OK signal from the PSU 10, the control module 206 determines that the external power source is not operating.

In step S3, the control module 206 determines whether the remaining capacity of the power storage unit 202 is sufficient. The control module 206 obtains charging capacity information from the power storage unit 202 and determines whether the remaining capacity of the power storage unit 202 is high enough to supply power to the server unit 40. If the remaining capacity is high enough to supply power to the server unit 40, the control module 206 determines that the remaining capacity is sufficient and the procedure goes to step S5. If the remaining capacity is too low to supply power to the server unit 40, the control module 206 determines that the remaining capacity is not sufficient and the procedure goes to step S4.

In step S4, the server unit 40 stops working Since the power storage unit 202 cannot provide enough power to keep the server unit 40 operating, the control module 206 stops discharging the power storage unit 202 and stops operating the converting unit 200.

In step S5, the converting unit 200 converts the second DC power of the power storage unit 202 to the second AC power and provides the second AC power to the PSU 10. Since the remaining capacity is sufficient, the control module 206 controls the power storage unit 202 to discharge and controls the converting unit 200 to convert the second DC power to the second AC power.

In step S6, the PSU 10 converts the second AC power to the third DC power to supply power to the server unit 40.

In step S7, the server unit 40 keeps operating and to backup data thereby preventing data loss.

The above power management system and method is operated by using the power backup unit 20 to store DC power from the PSU 10 when the external power source is operating. Thus, the power backup unit 20 can use the control module 206 to control the power storage unit 202 for supplying power to the PSU 10 when the external power source is shut down. Since the power backup unit 20 directly connects the PSU 10 of the server unit 40 and directly uses the first DC power of the PSU 10 to store the DC power, an extra rectifier is not needed. Therefore, extra conversion process and the power consumption of the extra rectifier can be prevented and cost of the server system can be decreased. In addition, the system and method also save the space since there is no necessary to install an external uninterruptable power supply outside of the server system.

While the disclosure has been described by way of example and in terms of preferred embodiment, it is to be understood that the disclosure is not limited thereto. To the contrary, it is intended to cover various modifications and similar arrangements as would be apparent to those skilled in the art. Therefore, the range of the appended claims should be accorded the broadest interpretation so as to encompass all such modifications and similar arrangements.

What is claimed is:

1. A power management system of a server system to supply power to a server unit, comprising:
a power supply unit configured to receive a first alternating current (AC) power from an external power source, to convert the first AC power to a first direct current (DC) power, and to provide the first DC power to the server unit; and
a power backup unit, further comprising:
a power storage unit configured to store a second DC power;
a charging unit connecting the power storage unit to the power supply unit to charge the power storage unit by the first DC power when the external power source provides the first AC power; and
a converting unit connecting the power storage unit to the power supply unit to convert the second DC power to a second AC power to provide the second AC power to the power supply unit when the external power source stops providing the first AC power.

2. The power management system of claim 1, wherein the power backup unit further comprises:
a control module configured to control the power storage unit, the charging unit, and the converting unit.

3. The power management system of claim 2, wherein the power supply unit transmits a high level signal to the control module when the external power source provides the first AC power.

4. The power management system of claim 3, wherein the charging unit charges the power storage unit when the control module receives the high level signal.

5. The power management system of claim 2, wherein the power supply unit transmits a low level signal to the control module when the external power source stops providing the first AC power.

6. The power management system of claim 5, wherein the power storage unit provides the second DC power to the converting unit and the converting unit converts the second DC power to provide the second AC power to the power supply unit, when the control module receives the low level signal.

7. The power management system of claim 2, wherein the control module further determines a remaining capacity of the power storage unit.

8. The power management system of claim 7, wherein the converting unit stops converting the second DC power when the remaining capacity is too low to supply power to the server unit.

9. A power management method for a server system to supply power to a server unit, comprising:
connecting an external power source to a power supply unit;
determining whether the external power source provides a first alternating current (AC) power;
converting the first AC power to a first direct current (DC) power by the power supply unit to provide the first DC power to the server unit, and storing the first DC power of the power supply unit to form a second DC power when the external power source provides the first AC power; and
converting the second DC power to a second AC power to provide the second AC power to the power supply unit when the external power source stops providing the first AC power.

10. The power management system of claim 9, further comprising
converting the second AC power to a third DC power by the power supply unit to provide the third DC power to the power supply unit when the second DC power is converted.

11. The power management system of claim 9, further comprising
transmitting a high level signal when the external power source provides the first AC power; and
transmitting a low level signal when the external power source stops providing the first AC power.
